(19) United States
(12) Patent Application Publication
(10) Pub. No.: US 2010/0288145 A1
(43) Pub. Date: Nov. 18, 2010

(54) HIGH SPEED PRINTED PRODUCT REORIENTATION METHOD AND APPARATUS

(75) Inventors: Joseph Adrian St. Ours, Lee, NH (US); Mark Anthony Wingate, New Durham, NH (US); David Elliot Whitten, Barrington, NH (US)

Correspondence Address: Davidson, Davidson & Kappel, LLC, 485 7th Avenue, 14th Floor, New York, NY, 10018, US

(73) Assignee: Goss International Americas, Inc., Durham, NH (US)

(21) Appl. No.: 12/770,512

(22) Filed: Apr. 29, 2010

Related U.S. Application Data
(60) Provisional application No. 61/173,813, filed on Apr. 29, 2009.

(51) Int. Cl. B41F 13/56; B41F 13/54

(52) U.S. Cl. 101/227; 101/232

(57) ABSTRACT

A printing press is provided. The printed press includes a plurality of printing units printing on a web and a folder for processing the web. The folder includes a cutter for cutting the web into printed products and a nip section for reorienting the printed products. The nip section includes a first pair of nip rolls, a second pair of nip rolls and at least one motor driving the first pair of nip rolls and the second pair of nip rolls, the at least one motor driving the first pair of nip rolls at different velocities than the second pair of nip rolls to reorient the printed products. A method for reorienting printed products in printing press is also provided.

Priority is claimed to U.S. Provisional Application No. 61/173,813 filed Apr. 29, 2009, and hereby incorporated by reference herein.

The present invention relates generally to transporting printed products and more specifically to a method and apparatus for reorienting printed products in a folder.

### BACKGROUND OF INVENTION

Conventional combination folders may be used to create multiple types of printed products required in commercial printing. FIG. 1 shows an example of an existing combination jaw folder 200 that can produce half-folded and quarter-folded printed products. Jaw folder 200 includes a former 202 longitudinally folding a web or ribbons. The longitudinally folded web is then cut into successive separate printed products or signatures, which pass to a first jaw fold cylinder 206 and a second jaw fold cylinder 208. Jaw fold cylinders 206, 208 are high speed fold cylinders that act together to produce a first cross fold in each printed product. The cross-folded signatures are delivered at high speeds to a diverter device 210, which diverts the half-folded printed products into two separate streams. One stream is directed to an upper slow-down section 212, which decelerates the printed products for quarter-folding by an upper chopper fold section 216. The other stream is directed to a lower slow-down section 214, which decelerates the printed products for quarter-folding by a lower chopper fold section 218.

If a chopper fold is not required for the particular printed products being produced, then the diverted printed products pass through the chopper fold sections 216, 218 without being quarter-folded and enter into respective upper and lower end delivery fans and conveyors 220, 222, where the printed products exit combination folder 200. Due to the way the chopper fold is created, there is typically respective upper and lower side delivery fan and conveyors 224, 226 to transport the quarter-folded printed products out of combination folder 200. A significant amount of hardware and expense is required to compensate for the lower speed limitations of the chopper fold mechanisms. Because the quarter-folded printed products exit the folder from separate side streams at side delivery fans and conveyors 224, 226, instead of at end delivery fans and conveyors 220, 222, extra floor space and added complexity is required. Using multiple deliveries may add significant cost because floor space at a printing plate is usually at a premium and separate processing equipment (i.e., gripper chains) are required for the deliveries.

### BRIEF SUMMARY OF THE INVENTION

A printing press is provided. The printed press includes a plurality of printing units printing on a web and a folder for processing the web. The folder includes a cutter for cutting the web into printed products and a nip section for reorienting the printed products. The nip section includes a first pair of nip rolls, a second pair of nip rolls and at least one motor driving the first pair of nip rolls and the second pair of nip rolls, the at least one motor driving the first pair of nip rolls at different velocities than the second pair of nip rolls to reorient the printed products.

A method for reorienting printed products in printing press is also provided. The method includes controlling a printed product with a first pair and a second pair of nip rolls; reorienting the printed product by rotating the first pair of nip rolls at first velocities and rotating the second pair of nip rolls at second velocities different from the first velocities; and releasing the printed product from the first pair and second pair of nip rolls.

### BRIEF DESCRIPTION OF THE DRAWINGS

The present invention is described below by reference to the following drawings, in which:

FIG. 1 shows an example of an existing combination jaw folder;

FIGS. 2a to 2d show sequential plan views and FIGS. 3a to 3d show sequential perspective views of a printed product reorienting apparatus horizontally transporting printed products according to an embodiment of the present invention;

FIGS. 4a to 4d show sequential perspective views of a printed product reorienting apparatus vertically transporting printed products according to an embodiment of the present invention;

FIG. 5 shows a graph illustrating the rotational velocities of nip pairs of the printed product reorienting apparatus shown in FIGS. 2a to 3d as a function of time according to one embodiment of the present invention;

FIGS. 6a to 6d shows sequential views of an embodiment of the present invention where nip pairs decelerate printed products as the nip pairs reorient the printed products;

FIG. 7 shows a graph illustrating the rotational velocities of nip pairs shown in FIGS. 6a to 6d as a function of time according to one embodiment of the present invention;

FIGS. 8a to 8d show sequential views of nip pairs accelerating and reorienting printed products according to one embodiment of the present invention;

FIG. 9 shows a graph illustrating the rotational velocities of nip pairs shown in FIGS. 8a to 8d as a function of time according to one embodiment of the present invention;

FIGS. 10a to 10c show nip pairs reorienting printed product less than ninety degrees according to further embodiments of the present invention;

FIGS. 11a and 11b nip pairs reorienting printed products less than ninety degrees while decelerating the printed products for shingling according to further embodiments of the present invention;

FIGS. 12a to 12c show nip pairs decelerating and reorienting printed products according to further embodiments of the present invention;

FIGS. 13a and 13b show sequential views of nip pairs creating a shingled stream of printed products according to one embodiment of the present invention;

FIGS. 14a to 14e nip pairs that are offset from centers of the incoming printed products according to further embodiments of the present invention;

FIG. 15 shows schematic view of a combination folder according to an embodiment of the present invention;

FIG. 16 shows a schematic view of a printing press according to an embodiment of the present invention;

FIG. 17 shows a schematic view of a former folder according to an embodiment of the present invention; and

FIG. 18 shows nip pairs of the former folder shown in FIG. 17 reorienting printed products that are longitudinally folded in half.

### DETAILED DESCRIPTION

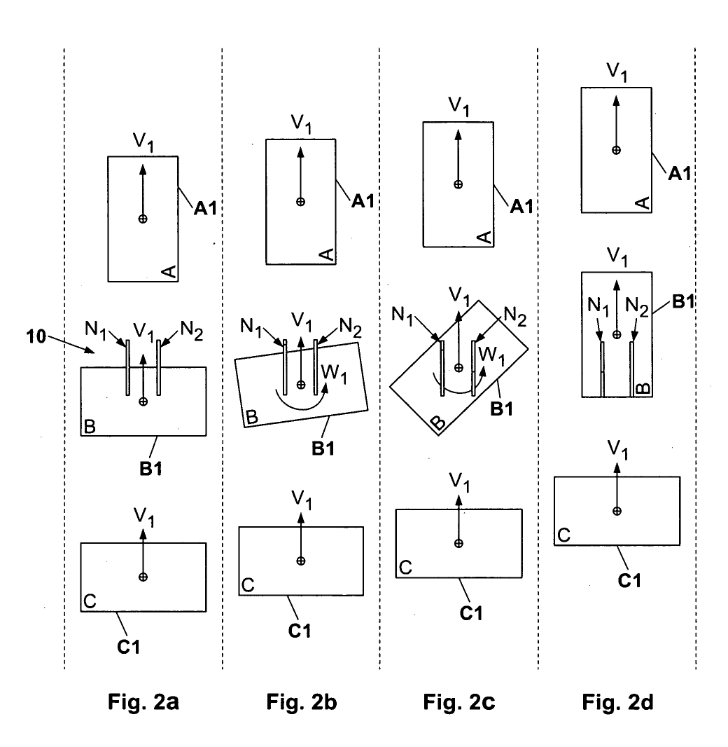

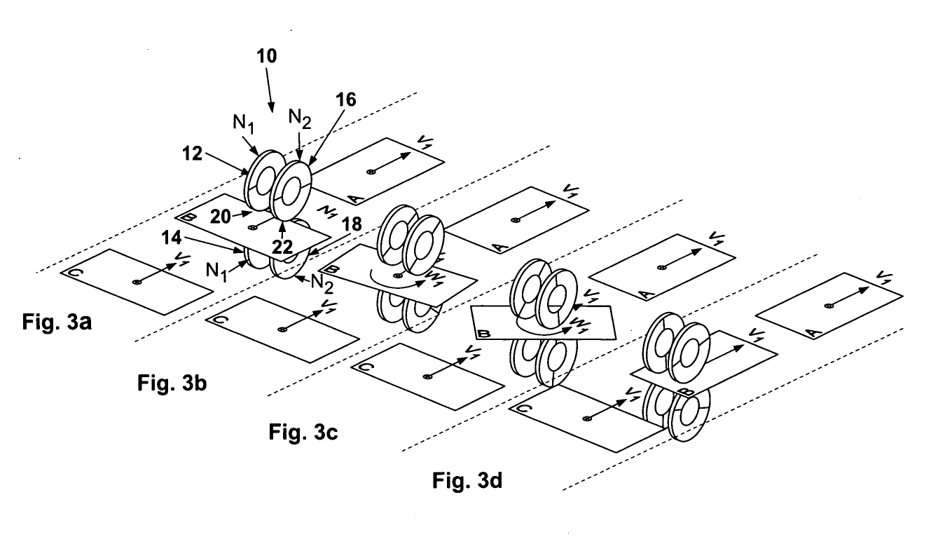

FIGS. 2a to 2d show sequential plan views of a printed product reorienting apparatus 10 according to an embodiment of the present invention. FIGS. 3a to 3d show sequential perspective views of printed product reorienting apparatus 10 that correspond to FIGS. 2a to 2d, respectively. Printed product reorienting apparatus 10 includes a nip section including two nip pairs N₁, N₂. As shown in FIGS. 3a to 3d, nip pairs N₁, N₂ include respective upper rolls 12, 16 and respective lower rolls 14, 18 that contact printed products A, B, C at respective nips 20, 22. In the embodiment in FIGS. 2a to 3d, nip rolls 12 to 18 reorient printed products A, B, C traveling in a horizontal plane. Nip rolls 12 to 18 reorient printed products A, B, C approximately ninety degree from an initial orientation to a new orientation while nip rolls 12 to 18 transport printed products A, B, C in the horizontal plane.

Nip rolls 12, 16 are rotated about a first axis above the path of printed products A, B, C and nip rolls 14, 18 are rotated about a second axis below the path of printed products A, B, C. A first servo motor drives nip pair N₁ by rotating nip rolls 12, 14 about the first and second axes, respectively, at the same velocity. A second servo motor drives nip pair N₂ by rotating nip rolls 16, 18 about the first and second axes, respectively, at the same velocity. In order to reorient printed products, nip pair N₁ is driven at a different velocity than nip pair N₂ and the degree of reorienting is controlled by driving nip pairs N₁, N₂ at varying velocities so nip rolls 12 to 18 follow pre-defined motion profiles. As printed products A, B, C pass through nips 20, 22, the interaction between printed products A, B, C and the rotating rolls 12 to 18 causes each printed product printed products A, B, C to continue forward horizontally while the printed product is rotated from the initial orientation to the new orientation. As shown in FIGS. 2a and 3a, printed products are transported to nip rolls 12 to 18 at a velocity V₁ in the initial orientation and are released by nip rolls 12 to 18 in the new orientation. Printed product C is shown being transported towards nip rolls 12 to 18 in the initial orientation, with a first edge C1 parallel to the axes of nip rolls 12 to 18. Printed product A is shown being transported away from nip rolls 12 to 18 after printed product A was reoriented approximately ninety degrees from the initial orientation to the new orientation by nip rolls 12 to 18 and a first edge A1 of printed product A is perpendicular how first edge A1 was oriented in the initial orientation. Printed product B is shown in the initial orientation as printed product B enters into contact with nip rolls 12 to 18 as printed product B is traveling in the initial orientation with a first edge B1 parallel to the axes of nip rolls 12 to 18.

As shown in FIGS. 2b and 3b, after printed product B enters nips 20, 22, nip rolls 12 to 18 begin rotating printed product B at an angular velocity W1 as nip rolls 12 to 18 continue to drive printed product B forward at velocity V1. The rotation of printed product B by nip rolls 12 to 18 is accomplished by rotating rolls 12, 14 at a lower velocity than nip rolls 16, 18. Rotating nip rolls 16, 18 faster than nip rolls 12, 14 causes nip rolls 16, 18 to apply a greater velocity to printed product B than nip rolls 12, 14, which causes the portion of printed product B in contact with nip rolls 16, 18 to move forward with respect to the portion of printed product B in contact with nip rolls 12, 14. Nip rolls 12 to 18 reorient printed product B so that first edge B1 is angled with respect to how first edge B1 was arranged in the initial orientation as shown in FIGS. 2a and 3a.

As shown in FIGS. 2c and 3c, nip rolls 12 to 18 continue to rotate printed product B at angular velocity W1 as nip rolls 12 to 18 continue to drive printed product B forward at velocity V1. Nip rolls 12 to 18 continue to reorient printed product B so that the angle with respect to how first edge B1 was arranged in the initial orientation increases. In the view shown in FIGS. 2c and 3c, nip rolls 12 to 18 have rotated printed product B approximately halfway to the new desired orientation.

As shown in FIGS. 2d and 3d, nip rolls 12 to 18 have rotated printed product B to the new desired orientation such that first edge B1 is approximately perpendicular to how first edge B1 was arranged in the initial orientation as shown in FIGS. 2a and 3a. As first edge B1 is reoriented into the new orientation, the servomotors adjust the rotation of nip rolls 12 to 18 so nip rolls 12 to 18 are rotating at the same velocity and have surface velocities equal to velocity V1. Once printed product B is in the new desired orientation, both nip pairs N₁, N₂ are driven at the same angular velocity. Nip pairs N₁, N₂ may continue to drive printed product B out of the control of nip pairs N₁, N₂ at velocity V1, but nip pairs N₁, N₂ no longer adjust the orientation of printed product B. Nip pairs N₁, N₂ then take control of the next incoming printed product C.

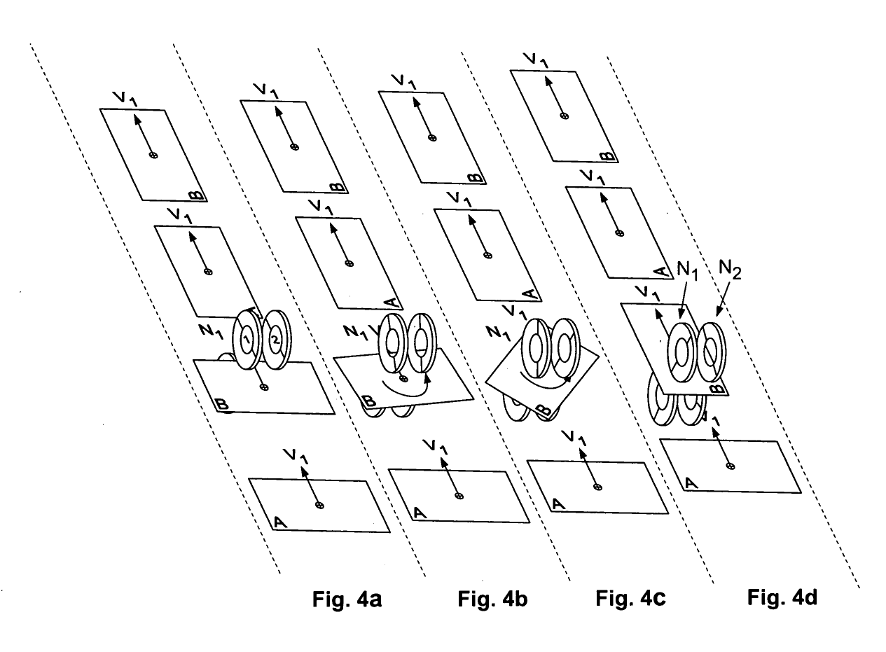

FIGS. 4a to 4d show nip pairs N₁, N₂ transporting printed products A, B in the same manner as in FIGS. 2a to 2d and 3a to 3d, but with the axes of nip rolls 12 to 18 aligned to reorient printed products A, B traveling in a vertical plane, instead of in the horizontal plane as shown in FIGS. 2a to 2d and 3a to 3d.

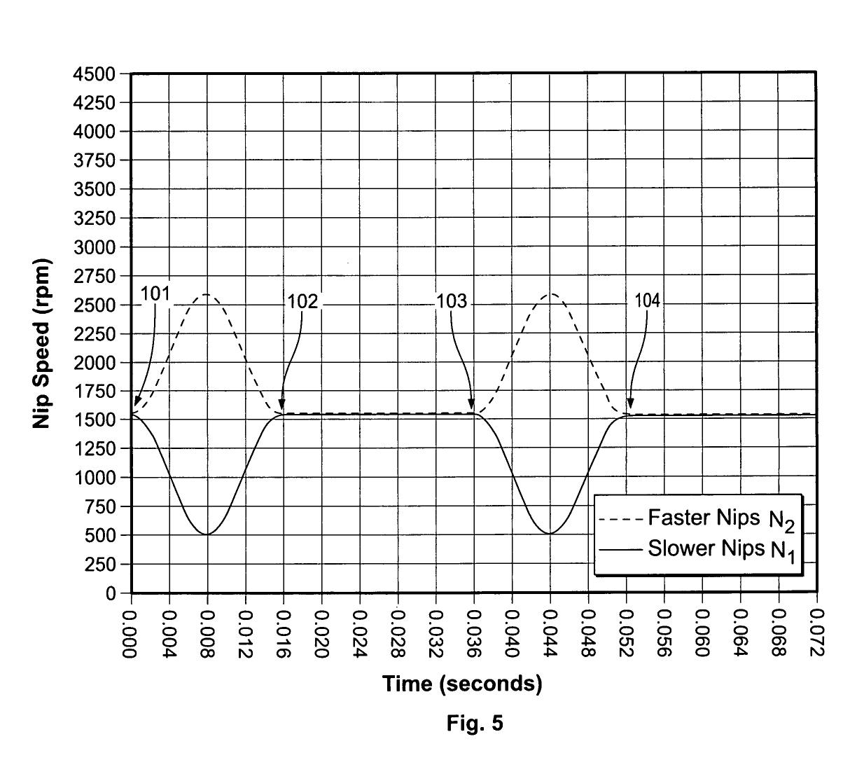

FIG. 5 shows a graph illustrating the rotational velocities of nip pairs N₁, N₂ as a function of time according to an exemplary embodiment of how nip pairs N₁, N₂ may be driven to transport printed products A, B in the same manner as in FIGS. 2a to 2d and 3a to 3d. At a point 101, printed product A, traveling at velocity V1, enters into contact with nip pairs N₁, N₂ while nip pairs N₁, N₂ are both rotated at the same rotational velocity (e.g., approximately 1550 rpm) and have surface velocities equal to V1. After point 101, nip pair N₁ is rapidly decelerated and nip pair N₂ is rapidly accelerated and nip pairs N₁, N₂ begin reorienting printed product A. After nip pair N₂ is rotated to a maximum velocity (e.g., approximately 2600 rpm) and nip pair N₁ is rotated to a minimum velocity (e.g., approximately 500 rpm), nip pair N₂ is decelerated and nip pair N₁ is accelerated so nip pairs N₁, N₂ have surface velocities equal to velocity V1 at a point 102. Between points 101 and 102, the acceleration and subsequent deceleration of nip pair N₂ and the deceleration and subsequent acceleration of nip pair N₁ are controlled so that printed product A is at the new desired rotation at point 102. At point 102, printed product A exits from nip pairs N₁, N₂ and nip pairs N₁, N₂ are both rotated at the same velocity until printed product B enters into contact with nip pairs N₁, N₂ at a point 103. After point 103, nip pair N₁ is decelerated and subsequently accelerated and nip pair N₂ is accelerated and subsequently decelerated in the same manner as between points 101 and 102 to reorient printed product B to the new desired orientation. At a point 104, printed product B exits from nip pairs N₁, N₂ and nip pairs N₁, N₂ are all rotated to have surface velocities equal to velocity V1 until a next printed product (i.e., printed product C in FIGS. 2a to 2d and 3a to 3d) enters into nip pairs N₁, N₂.

It should be noted that although FIGS. 2a to 2d, 3a to 3d and 4a to 4d show printed products A, B exiting the control of nip pairs N₁, N₂ at approximately ninety degrees as compared the initial orientation when entering nip pairs N₁, N₂, nip pairs N₁, N₂ may be used to orient printed products any desired amount of degrees based on the change in velocities of nip pairs N₁, N₂. A greater differential between the velocities that nip pairs N₁, N₂ are rotated as printed products are controlled by nip pairs N₁, N₂ leads to a greater degree of orientation change. Also, although the graph shown in FIG. 5 shows printed products A, B each entering and exiting nip pairs N₁, N₂ at the same velocity, as discussed below, nip pairs N₁, N₂ can be used to accelerate or decelerate printed products.

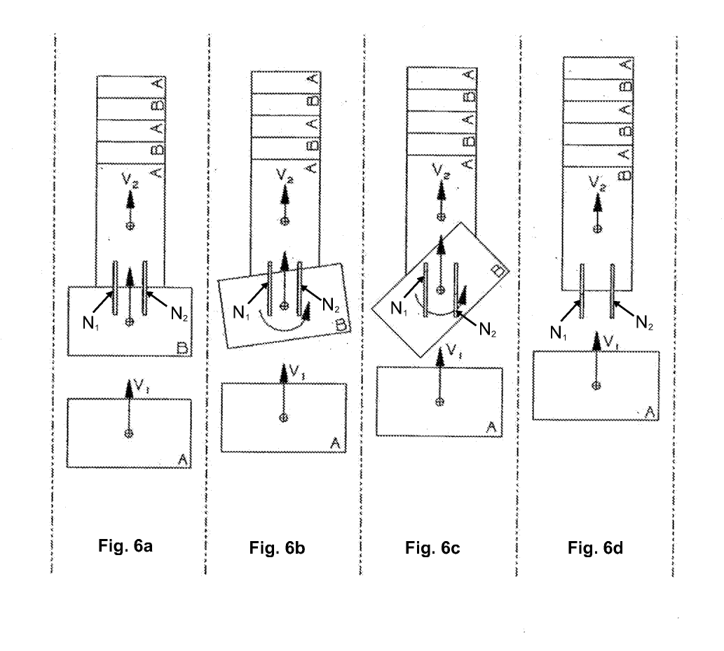

FIGS. 6a to 6d shows sequential views of an embodiment of the present invention where nip pairs N₁, N₂ decelerate printed products A, B as nip pairs N₁, N₂ reorient printed products A, B. Nip pairs N₁, N₂ receive printed products A, B traveling at velocity V1 and decelerate printed products to a velocity V2 while reorienting printed products A, B approximately ninety degrees. The deceleration of printed products A, B causes printed products A, B to be shingled.

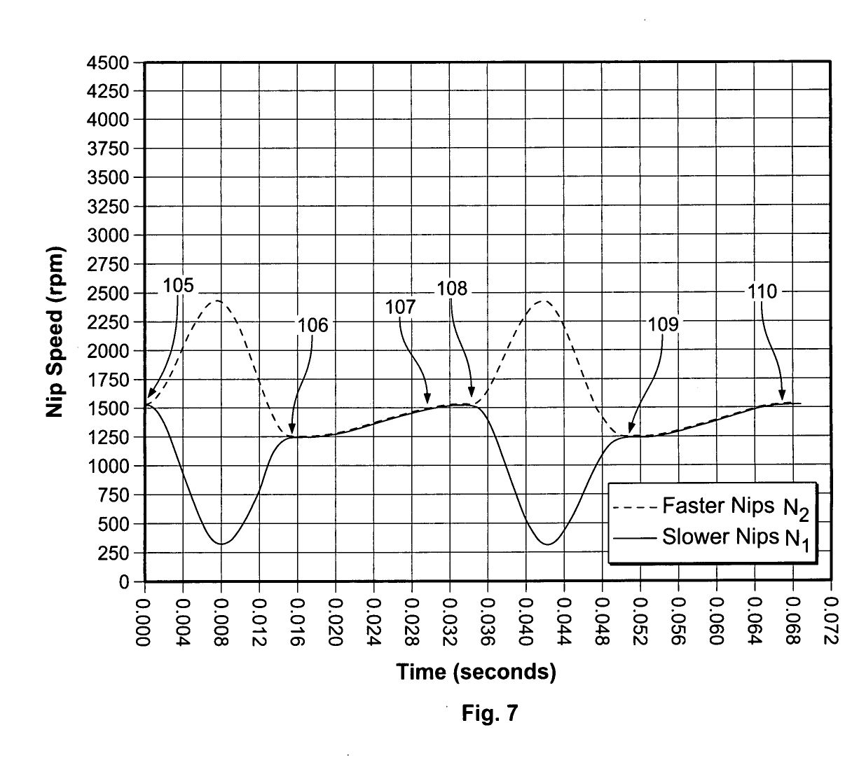

FIG. 7 shows a graph illustrating the rotational velocities of nip pairs N₁, N₂ as a function of time according to an exemplary embodiment of how nip rolls 12 to 18 may be rotated to transport and decelerate printed products A, B in the same manner as in FIGS. 6a to 6d. At a point 105, printed product A, traveling at velocity V1, enters into contact with nip pairs N₁, N₂ while nip pairs N₁, N₂ are both rotated at the same rotational velocity (e.g., approximately 1550 rpm) and have surface velocities equal to V1. After point 105, nip pair N₁ is rapidly decelerated and nip pair N₂ is rapidly accelerated and nip pairs N₁, N₂ begin reorienting printed product A. After nip pair N₂ is rotated to a maximum velocity (e.g., approximately 2450 rpm) and nip pair N₁ is rotated to a minimum velocity (e.g., approximately 350 rpm), nip pair N₂ is decelerated and nip pair N₁ is accelerated to a rotational velocity (e.g., approximately 1250 rpm) at which nip pairs N₁, N₂ have surface velocities equal to a velocity V2 that is less than velocity V1 at a point 106. Between points 105 and 106, the acceleration and subsequent deceleration of nip pair N₂ and the deceleration and subsequent acceleration of nip pair N₁ are controlled so that printed product A is at the new desired rotation at point 106. At point 106, printed product A exits from nip pairs N₁, N₂. After point 106, in an area 107, nip pairs N₁, N₂ are accelerated to have surface velocities equal to velocity V1 as printed product B enters into nip pairs N₁, N₂. At a point 108, printed product B enters into nip pairs N₁, N₂ at the initial orientation and nip pairs N₁, N₂ have surface velocities equal to V1. After point 108, nip pair N₁ is decelerated and subsequently accelerated and nip pair N₂ is accelerated and subsequently decelerated in the same manner as between points 105 and 106 to reorient printed product B to the new desired orientation and decelerate printed product B for release at point 109 for shingling. After point 109, in an area 110, nip pairs N₁, N₂ are accelerated to have surface velocities equal to velocity V1 as a next printed product (another printed product A as shown in FIGS. 6a to 6d) enters into nip pairs N₁, N₂.

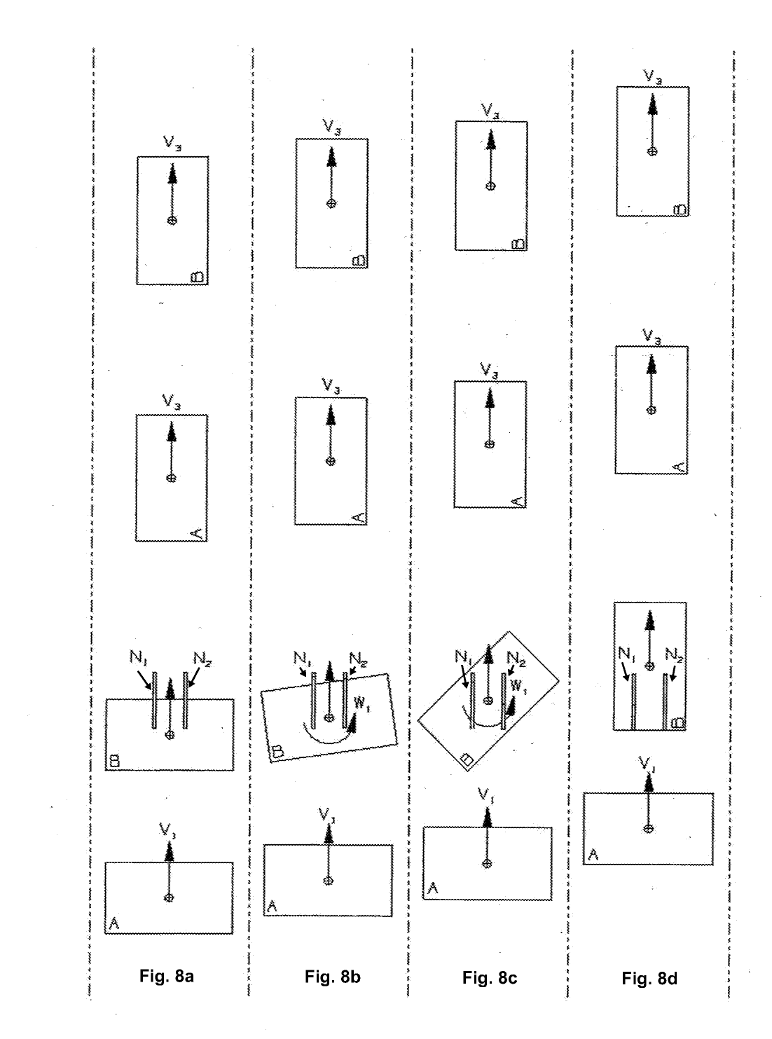

FIGS. 8a to 8d show sequential views of nip pairs N₁, N₂ accelerating and reorienting printed products according to one embodiment of the present invention. Nip pairs N₁, N₂ accelerate printed products from velocity V1 to a velocity V3 while reorienting printed products A, B approximately 90 degrees. The acceleration of printed products A, B by nip pairs N₁, N₂ causes printed products A, B to be separated from each other by larger gaps after exiting nip pairs N₁, N₂ than printed products A, B were separated by before entering nip pairs N₁, N₂.

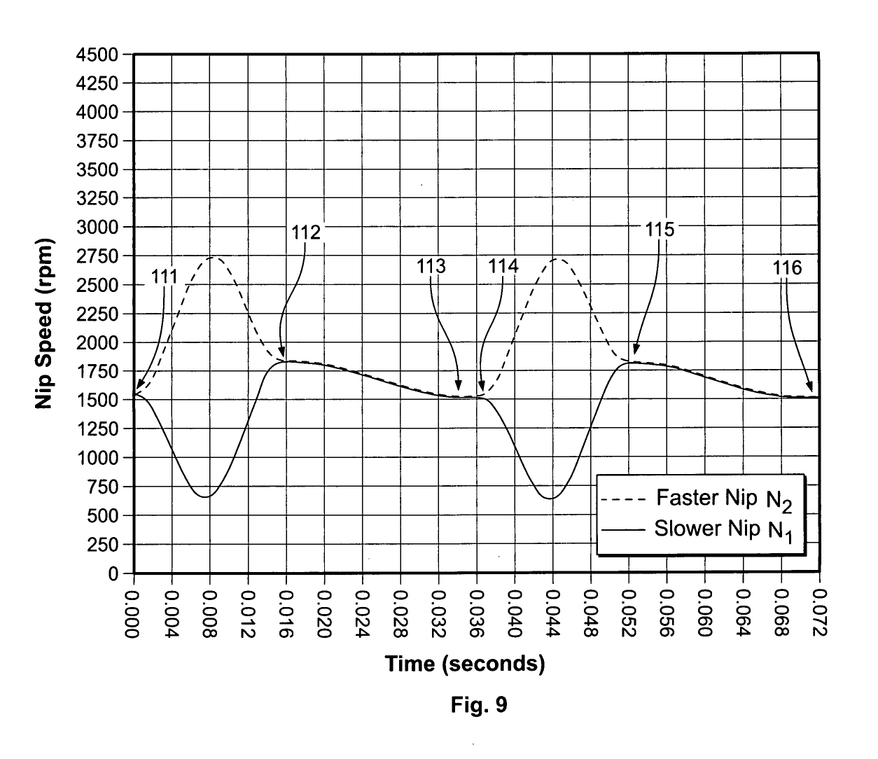

FIG. 9 shows a graph illustrating the rotational velocities of nip pairs N₁, N₂ as a function of time according to an exemplary embodiment of how nip rolls 12 to 18 may be driven to transport and accelerate printed products A, B in the same manner as in FIGS. 8a to 8d. At a point 111, printed product A, traveling at velocity V1, enters into contact with nip pairs N₁, N₂ while nip pairs N₁, N₂ are both rotated at the same rotational velocity (e.g., approximately 1550 rpm) and have surface velocities equal to V1. After point 111, nip pair N₁ is rapidly decelerated and nip pair N₂ is rapidly accelerated and nip pairs N₁, N₂ begin reorienting printed product A. After nip pair N₂ is rotated to a maximum velocity (e.g., approximately 2750 rpm) and nip pair N₁ is rotated to a minimum velocity (e.g., approximately 650 rpm), nip pair N₂ is decelerated and nip pair N₁ is accelerated to a rotational velocity (e.g., approximately 1850 rpm) at which nip pairs N₁, N₂ have surface velocities equal to a velocity V3 that is greater than velocity V1. Between points 111 and 112, the acceleration and subsequent deceleration of nip pair N₂ and the deceleration and subsequent acceleration of nip pair N₁ are controlled so that printed product A is at the new desired rotation at point 112. After point 112, in an area 113, nip pairs N₁, N₂ are decelerated to have surface velocities equal to velocity V1 as printed product B enters into nip pairs N₁, N₂. At a point 114, printed product B enters into nip pairs N₁, N₂ at the initial orientation and nip pairs N₁, N₂ have surface velocities equal to V1. After point 114, nip pair N₁ is decelerated and subsequently accelerated and nip pair N₂ is accelerated and subsequently decelerated in the same manner as between points 111 and 112 to reorient printed product B to the new desired orientation and accelerate printed product B for release at point 115. After point 115, in an area 116, nip pairs N₁, N₂ are decelerated to have surface velocities equal to velocity V1 as a next printed product (another printed product A as shown in FIGS. 8a to 8d) enters into nip pairs N₁, N₂.

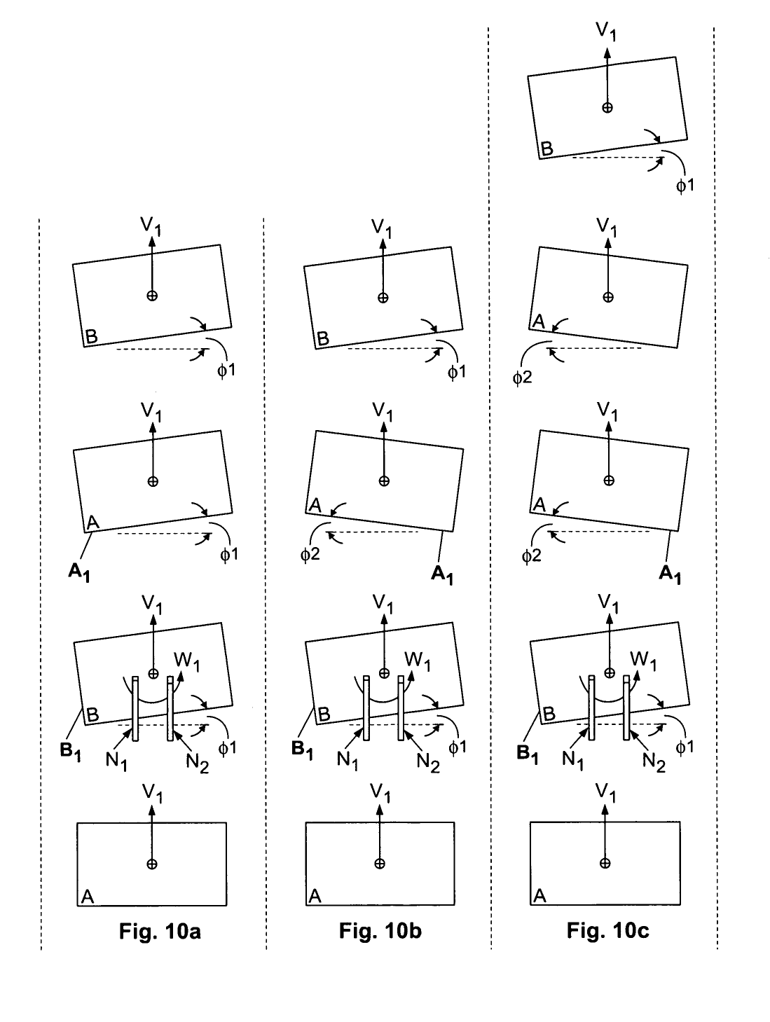

FIGS. 10a to 10c show nip pairs N₁, N₂ reorienting printed products A, B less than ninety degrees and releasing printed product A, B at velocity V1 according to further embodiments of the present invention. In FIG. 10a, nip pairs N₁, N₂ reorient printed products A, B are alternately fed to nip pairs N₁, N₂ from the first orientation to a new desired orientation where printed products A, B exit from nip pairs N₁, N₂ with first edges A1, B1 oriented at an angle Ø₁ with respect to the initial orientation first edges A1, B1 were in when printed products A, B entered nip pairs N₁, N₂.

In FIG. 10b, printed products A, B are alternately fed to nip pairs N₁, N₂ and printed products A are rotated in a first direction by nip pairs N₁, N₂ and printed products B are rotated in a second direction by nip pairs N₁, N₂. Printed products A exit from nip pairs N₁, N₂ with first edges A1, B1 oriented at an angle Ø₂ with respect to the initial orientation first edges A1, B1 were in when printed products A, B entered nip pairs N₁, N₂. Printed products B exit from nip pairs N₁, N₂ with first edges A1, B1 oriented at an angle Ø₁ with respect to the initial orientation first edges A1, B1 were in when printed products A, B entered nip pairs N₁, N₂. During the reorientation of printed products A by nip pairs N₁, N₂, nip pair N₂ is rotated at a higher velocity than nip pair N₁ and during the reorientation of printed products A by nip pairs N₁, N₂, nip pair N₁ is rotated at a higher velocity than nip pair N₂.

In FIG. 10c, two printed products A are successively fed to nip pairs N₁, N₂ and then two printed products B are successively fed to nip pairs N₁, N₂. As shown in FIG. 10b, printed products A are rotated in a first direction at angle Ø₂ by nip pairs N₁, N₂ and printed products B are rotated at angle Ø₁in a second direction by nip pairs N₁, N₂. FIG. 10c illustrates that there is no limitation on the pattern and intervals and angles of orientation that can be achieved using nip pairs N₁, N₂.

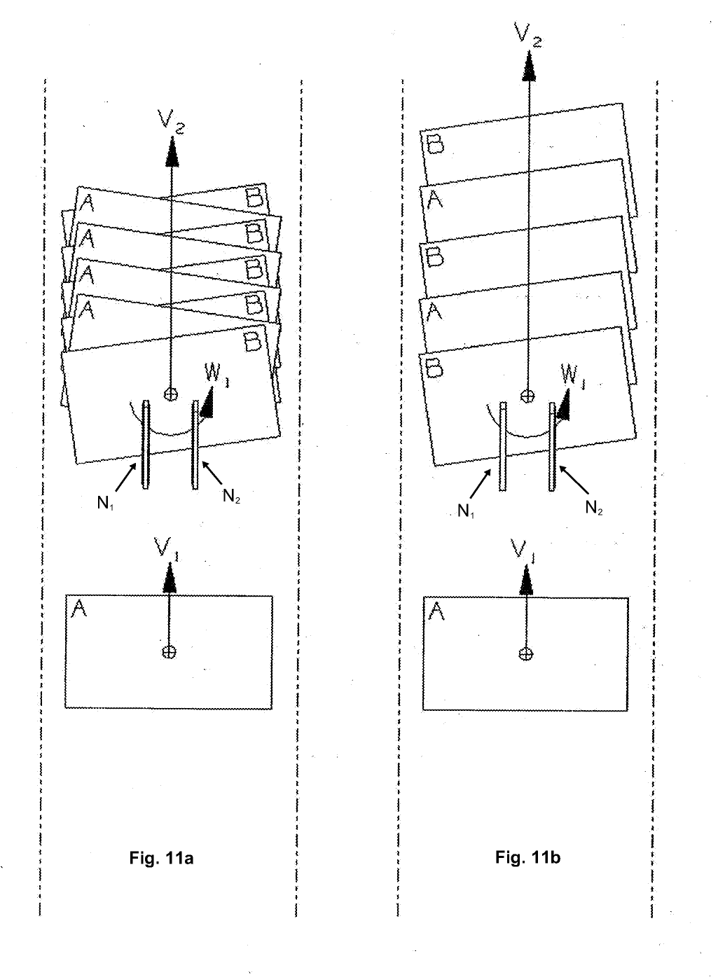

FIGS. 11a and 11b nip pairs N₁, N₂reorienting printed products A, B less than ninety degrees while decelerating the printed products A, B for shingling according to further embodiments of the present invention. In FIG. 11a, similar to the embodiment shown in FIG. 10b, printed products A, B are alternately fed to nip pairs N₁, N₂ and printed products A are rotated in a first direction by nip pairs N₁, N₂ and printed products B are rotated in a second direction by nip pairs N₁, N₂. However, as shown in FIG. 11a, nip pairs N₁, N₂ also decelerate printed products A, B to orient printed products A, B in alternating shingled manner. In FIG. 11b, similar to the embodiment shown in FIG. 10a, printed products A, B are alternately fed to nip pairs N₁, N₂ and printed products A, B are rotated in a the same direction at the same angle by nip rollers 12, 18. However, as shown in FIG. 11b, printed products A, B are also decelerated, so printed products A, B are oriented at the same angle in shingled manner by nip pairs N₁, N₂.

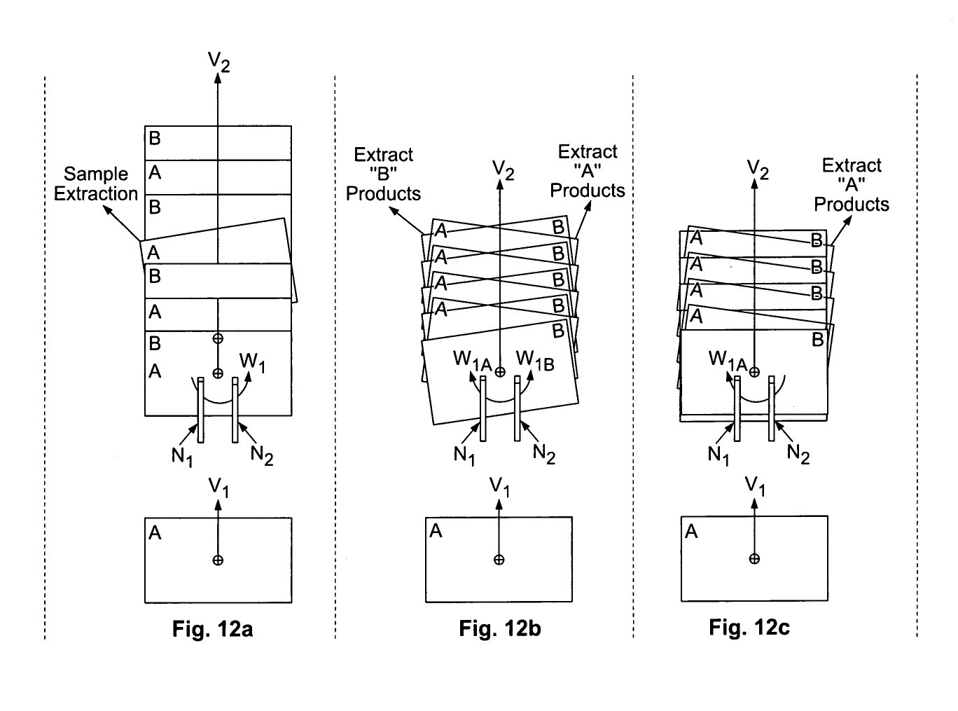

FIGS. 12a to 12c show nip pairs N₁, N₂ decelerating and reorienting printed products A, B that are alternately fed to nip pairs N₁, N₂ according to further embodiments of the present invention. In FIG. 12a, nip pairs N₁, N₂ only reorient one of printed products A. The new orientation of the reoriented printed product A exposes a corner of the reoriented printed product A that may be used in a secondary operation downstream of nip pairs N₁, N₂ for inspection or disposal purposes. Any number of printed products A, B may be reoriented so the reoriented printed products may be removed for use in a secondary operation.

In FIG. 12b, as similarly shown in FIG. 11a, printed products A are rotated in a first direction by nip rollers 12 to 18 and printed products B are rotated in a second direction by nip rollers 12 to 18. Printed products A are rotated by nip pairs N₁, N₂ at an angular velocity W1A while printed products B are rotated by nip pairs N₁, N₂ at a different angular velocity W1B. In this embodiment, printed products A, B can be separated out into separate product streams further processing.

In FIG. 12c, printed products A are rotated at angular velocity W1A into a new orientation by nip rollers 12, 18, but printed products B are left in the initial orientation. Only printed products A are reoriented so printed products A can be separated from the stream of printed products B.

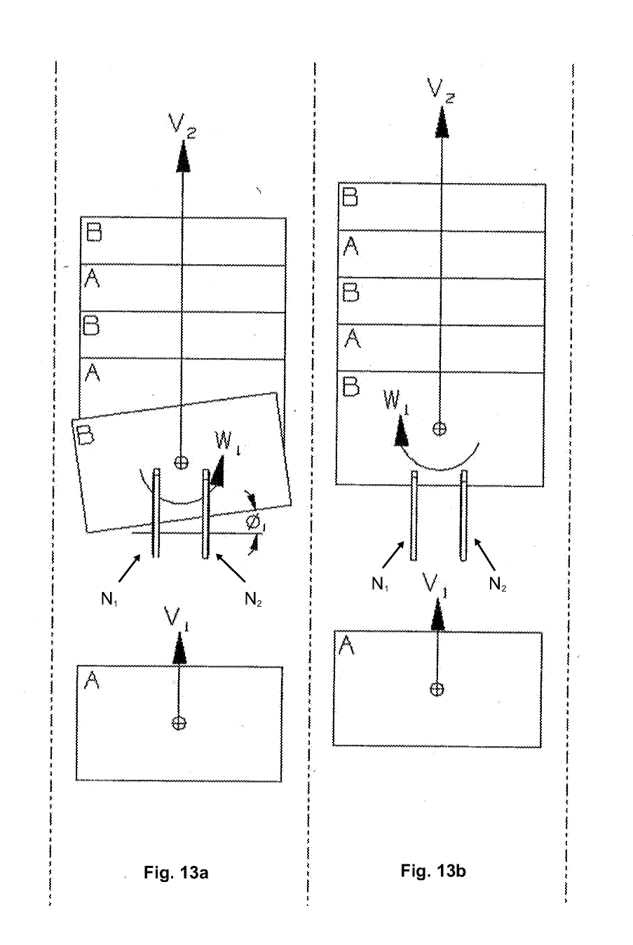

FIGS. 13a and 13b show sequential views of nip pairs N₁, N₂ creating a shingled stream of printed products A, B according to one embodiment of the present invention. In FIG. 13a, printed product B, which entered nips 20, 22 at velocity V1, has been reoriented from the initial orientation by angle Ø₁ by nip pairs N₁, N₂ so that the right upper corner passes over the adjacent downstream printed product A, initiating a shingle. Once the shingle is initiated, nip pairs N₁, N₂ then rotate printed product B backward by angle Ø₁ to the initial orientation, as shown in FIG. 13b. Because the nip pairs N₁, N₂ also decelerate the printed products A, B from velocity V1 to velocity V2, a continuous in-line product shingle stream results.

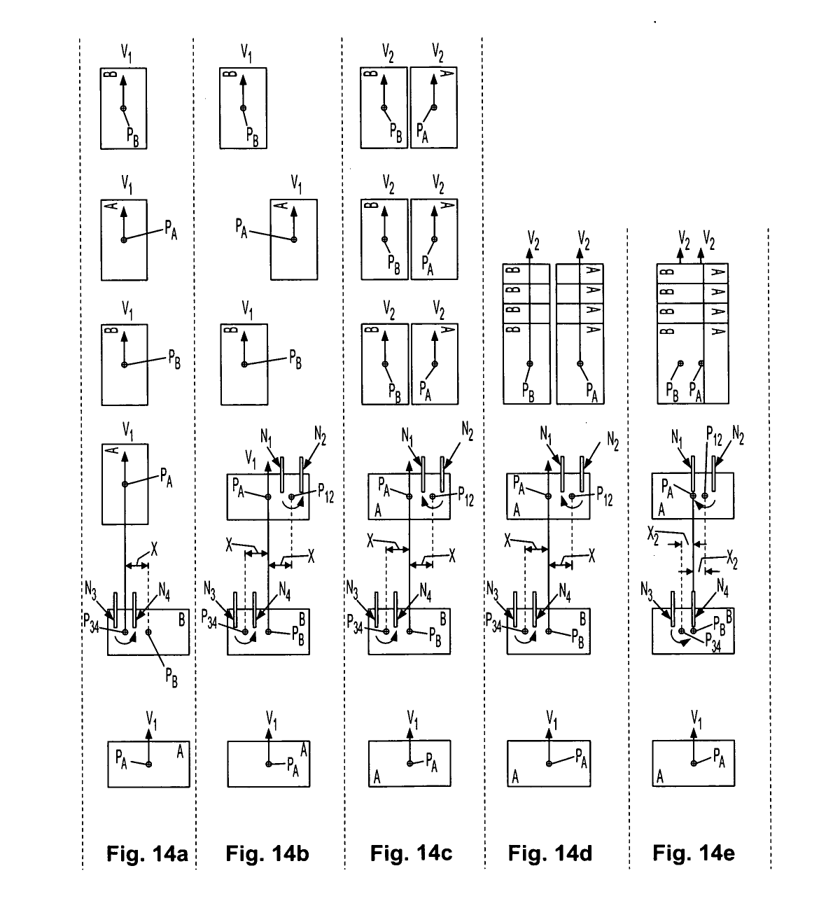

FIGS. 14a to 14e show further embodiments of the present invention where printed products A, B are alternately fed to nip pairs N₃, N₄ that may be used with nip pairs N₁, N₂. Nip pairs N₃, N₄ are configured and may be operated in the same manner as nip pairs N₁, N₂. Similar to nip pairs N₁, N₂ a servo motor drives nip pair N₃ by rotating nip rolls of nip pair N₃ about different axes at the same velocity as each other. Another servo motor, independent from the servo motor driving nip pair N₃, drives nip pair N₄ by rotating nip rolls 16, 18 about nip rolls of nip pair N₄ at the same velocity as each other. In FIG. 14a, a center P₃₄ of nip pairs N₃, N₄ are offset from centers P_{A}, P_{B} of printed products A, B when printed products A, B are in the initial orientation and are entering into contact with nip pairs N₃, N₄ by a distance X. The location of nip pairs N₃, N₄ relative to centers P_{A}, P_{B} (i.e., the center of the product path) determines the new location of centers P_{A}, P_{B} after each printed product A, B is reoriented by nip pairs N₃, N₄ and is transported away from nip pairs N₃, N₄ in the new orientation. As shown in FIG. 14a, centers P_{A}, P_{B} are offset by distance X by nip pairs N₃, N₄ as printed products A, B are rotated from the initial orientation to the new orientation.

In FIG. 14b, four nip pairs N₁, N₂, N₃, N₄ are used to separate printed products A, B into separate streams. Nip pairs N₁, N₂, N₃, N₄ are arranged so that nip pairs N₃, N₄ are upstream of nip pairs N₁, N₂ and nip pairs N₁, N₂ are laterally offset from nip pairs N₃, N₄. In this arrangement, center P₃₄ of nip pairs N₃, N₄ is laterally offset in a first direction (i.e., left as shown in FIG. 14b) by distance X from centers P_{A}, P_{B} of printed products A, B when printed products A, B are in the initial orientation and are entering into contact with nip pairs N₃, N₄, and a center P₁₂ of nip pairs N₁, N₂ is laterally offset in a second direction (i.e., right as shown in FIG. 14b) by distance X from centers P_{A}, P_{B} of printed products A, B when printed products A, B are in the initial orientation and are entering into contact with nip pairs N₃, N₄. In this embodiment, nip pairs N₁, N₂ only reorient printed products A and nip pairs N₃, N₄ only reorient printed products B. Nip pairs N₁, N₂ rotate printed products A approximately ninety degrees to the right and nip pairs N₃, N₄ rotate printed products B approximately ninety degrees to the left. As a result, centers P_{A} of printed products A are shifted right by distance X during the reorientation by nip pairs N₁, N₂ and centers P_{B} of printed products B are shifted left by distance X during the reorientation by nip pairs N₃, N₄.

In FIG. 14c, nip pairs N₁, N₂, N₃, N₄ are arranged in the same manner with respect to each other and incoming printed products A, B as in FIG. 14b, except that nip pairs N₁, N₂, N₃, N₄ change the velocities of printed products A, B as printed products A, B are under the control of the respective nip pairs N₁, N₂, N₃, N₄ so that each printed product A is arranged laterally adjacent to one printed product B downstream of nip pairs N₁, N₂. After exiting the respective nip pairs N₁, N₂, N₃, N₄ printed products A, B travel at velocity V2 that is different from velocity V1 that printed products A, B enter the respective nip pairs N₁, N₂, N₃, N₄.

In FIG. 14d, nip pairs N₁, N₂, N₃, N₄ are arranged and operate in the same manner as in FIG. 14c, but nip pairs N₁, N₂, N₃, N₄ alter the velocities of the respective printed products A, B so that once printed products A, B are reoriented, printed products A, B are arranged in separate shingles with each printed product A arranged laterally adjacent to one printed product B.

In FIG. 14e, nip pairs N₁, N₂, N₃, N₄ operate in the same manner as in FIG. 14d; however, nip pairs N₁, N₂, N₃, N₄ are moved inward so the distance X between centers P_{A}, P_{B} of printed products A, B in the initial orientation and centers P₁₂, P₃₄ of nip pairs N₁, N₂, N₃, N₄ is decreased as compared with FIG. 14d. This arrangement of nip pairs N₁, N₂, N₃, N₄ causes the shingle stream of printed products A to be interwoven with the shingle stream of printed products B.

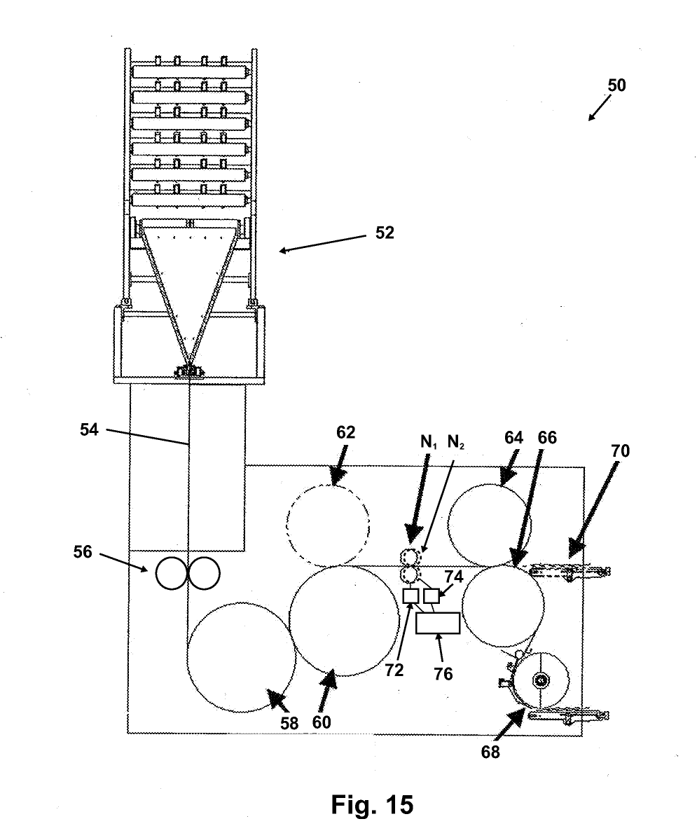

FIG. 15 shows an embodiment of a combination folder 50 according to an embodiment of the present invention. Combination folder 50 includes a former 52 longitudinally folding a web or ribbons 54. A cutter 56 cuts the longitudinally folded web 54 into successive separate printed products or signatures, which pass to a first jaw fold cylinder 58 and a second jaw fold cylinder 60 for cross-folding. The printed product then is passed to nip pairs N₁, N₂ in an initial orientation. Nip pairs N₁, N₂ are shown schematically offset from each other in FIG. 15 for clarity. Rollers 12, 14 (FIG. 3d) of nip pair N₁ are geared together so rollers 12, 14 may be driven by a first servo motor 72 and rollers 16, 18 (FIG. 3d) of nip pair N₂ are geared together so rollers 16, 18 may be driven by a second servo motor 74. Servo motors 72, 74 controlled by a controller 76 to reorient the printed product from the initial orientation to a new desired orientation. In a preferred embodiment, the printed product is reoriented by approximately ninety degrees for quarter-folding by quarter-fold jaw cylinders 64, 66. The printed product may then be passed to a single common end delivery fan and conveyor 68 or an optional second stream end delivery conveyor 70. Cylinders 64, 66 may also be simply used to collect the reoriented half-folded printed products instead of quarter-folding the reoriented half-folded printed products to provide an operator of folder 50 with additional product options. Quarter-fold jaw cylinders 64, 66 may also be included to create a second cross fold instead of quarter fold if desired. If a second cross fold product requires a quarter fold operation (chopped digest or delta), than an optional fold cylinder 62 may be provided downstream of second jaw fold cylinder 60 to provide for this requirement.

In one alternative embodiment, optional fold cylinder 62 may be omitted and fold cylinders 64, 66 may be used to create a second cross-folded in the already cross-folded printed products.

Although only one section of nip pairs N₁, N₂ is shown in FIG. 15, any number of sections of nip pairs N₁, N₂ may be used in folder 50 if desired. For example, any of the exemplary embodiments shown in FIGS. 2a to 14e may be used in folder 50 in the position where nip pairs N₁, N₂ are included in FIG. 15.

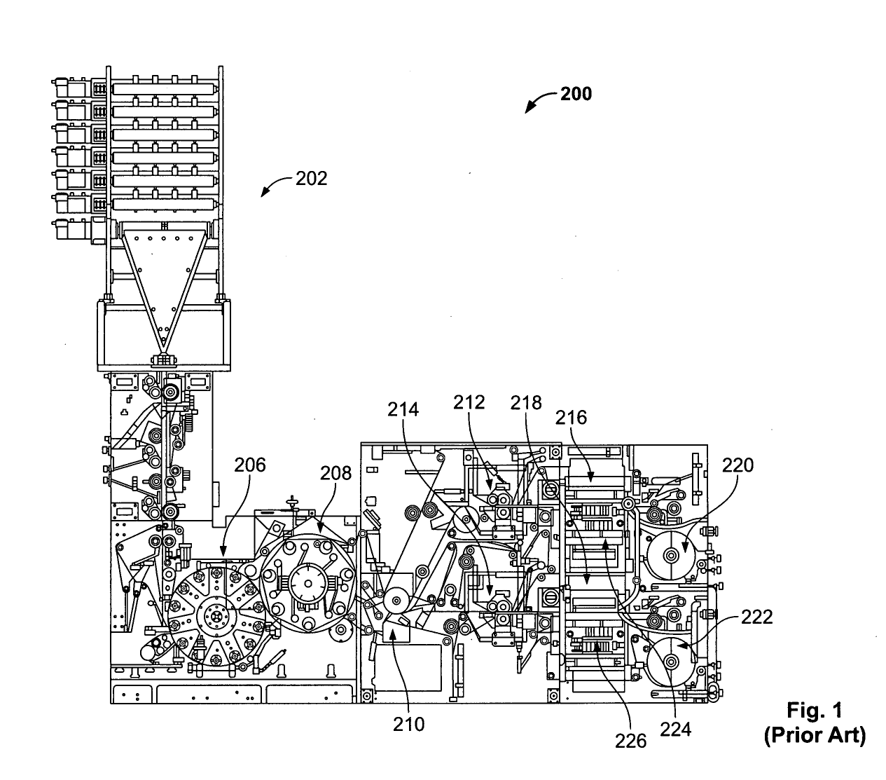

Combination folder 50 may advantageously allow for the elimination of hardware compared to combination folder 200 shown in FIG. 1. For example, with respect to combination folder 200, diverter device 210, lower and upper slow-down sections 212, 214, upper and lower chopper fold sections 216, 218, upper and lower side delivery fan and conveyors 224, 226 and upper and lower end delivery fans and conveyors 220, 222 may be replaced by nip pairs N₁, N₂, quarter-fold cylinders 64, 66 and optional second stream end delivery conveyor 70. By using at least one section of nip pairs N₁, N₂ in combination folder 50, high speed operations may advantageously be performed throughout all of combination folder 50. Additionally, all printed products produced in combination folder 50 may exit folder 50 from single common end delivery fan and conveyor 68 or optional second stream end delivery conveyor 70, which may significantly reduce printing plate floor space and post processing equipment demands.

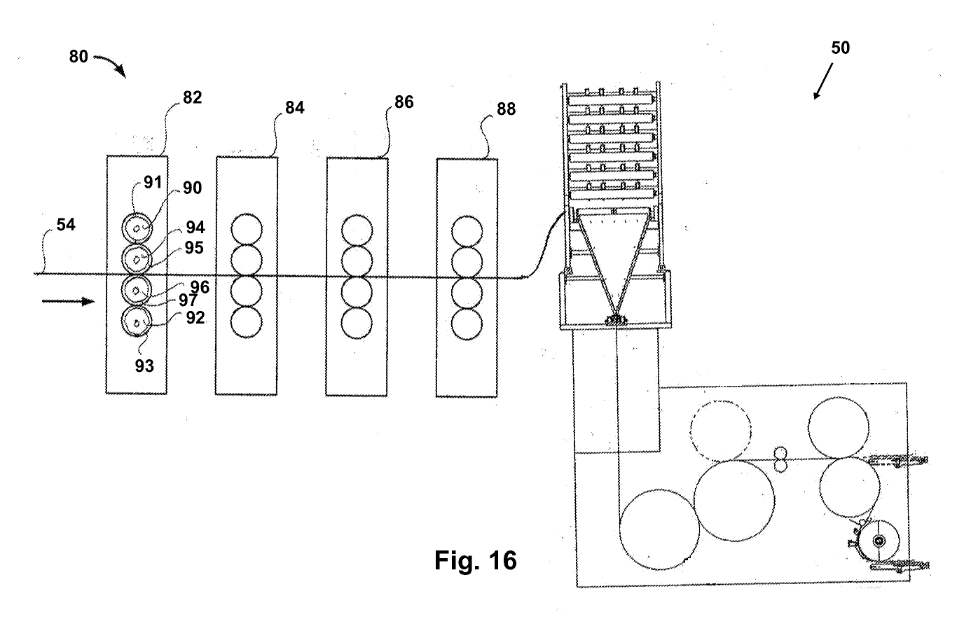

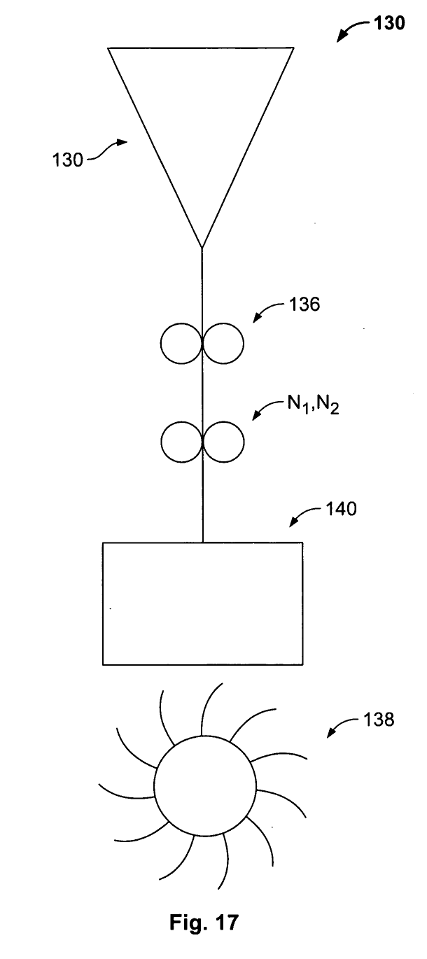

FIG. 16 shows a schematic view of a printing press 80 according to an embodiment of the present invention. Printing press 80 includes four perfecting offset printing units 82, 84, 86, 88 printing images on web 54. Each printing unit 82, 84, 86, 88 includes two plate cylinders 90, 92 equipped with respective printing plates 91, 93 and two blanket cylinders 94, 96 equipped with respective printing blankets 95, 97. After web 54 is printing by printing units 82, 84, 86, 88, web 54 is passed to combination folder 50 for processing. In another embodiment, combination folder 50 may be replaced by former folder 130 shown in FIG. 17.

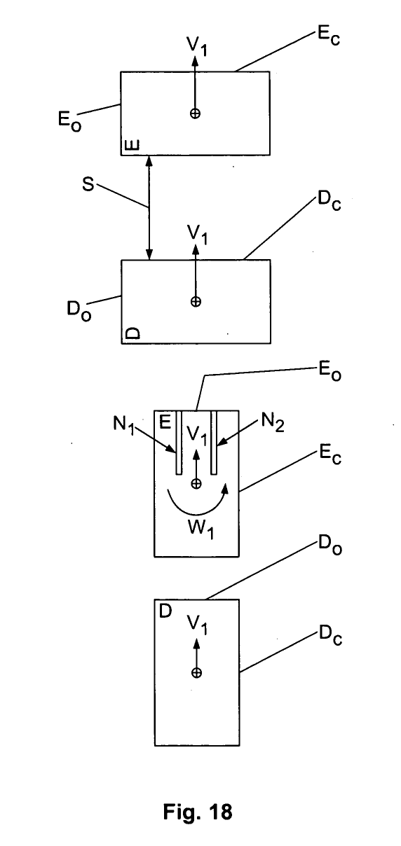

FIG. 17 shows a schematic view of a former folder 130 according to an embodiment of the present invention. Former folder 130 includes a former 132 longitudinally folding a web 134, which is cut into printed products D, E as shown in FIG. 18 by a cutter 136. As shown in FIG. 18, printed products D, E are then reoriented by nip pairs N₁, N₂ so printed products D, E are transported to at least one delivery fan 138 with closed (folded) edges D_{C}, E_{C} leading. A slow-down device 140 may be provided between nip pairs N₁, N₂ and delivery fan 138 to decelerate printed products D, E.

FIG. 18 shows nip pairs N₁, N₂ of former folder 130 shown in FIG. 17 reorienting printed products D, E that are longitudinally folded in half and include respective closed (folded) edges D_{C}, E_{C} and respective open edges D_{O}, E_{O}. Printed products D, E are formed as described above with respect to FIG. 17, by longitudinally folding web 134 and cross-cutting web 134 with cutter 136. Traditionally, printed products D, E are passed to delivery fans at full speed since there is very little, if any, head to tail space between successive printed products D, E to allow for printed products D, E to be slowed down between printed products D, E enter the delivery fans. Also, printed products D, E are passed to the delivery fans with open edges D_{O}, E_{O} leading, which may cause printed products D, E to be more susceptible to damage because printed products D, E may open as printed products D, E hit the bottom of pockets of the delivery fans.

In FIG. 18, a single stream of longitudinally folded printed products D, E enter into the control of nip pairs N₁, N₂ in an initial orientation with open edges D_{O}, E_{O} leading. Nip pairs N₁, N₂ reorient printed products D, E approximately ninety degrees so printed products D, E are released from nip pairs N₁, N₂ with closed edges D_{C}, E_{C} leading. Printed products D, E may then be delivered to delivery fan 138 with closed edges D_{C}, E_{C} leading, which may advantageously prevent printed products D, E from being damaged while landing in the pockets of the delivery fans. As shown in FIG. 18, the rotating of printed products D, E by nip pairs N₁, N₂ also creates additional space S between successive printed products D, E downstream from nip pairs N₁, N₂. Additional space S may allow for use of slowdown device 140 downstream from nip pairs N₁, N₂ to decelerate printed products D, E before printed products enter delivery fan 138. Using slowdown device 140 prior to the delivery fan 138 may reduce the slow-down demands typically required of delivery fans. Also, reorienting printed products D, E before printed products D, E enter delivery fan 138 may advantageously allow for elimination of bump-turns that are traditionally required after printed products exit delivery fans and are delivered onto conveyors.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press including:
a plurality of printing units printing on a web; and
a folder for processing the web, the folder including:
a cutter for cutting the web into printed products; and
a nip section for reorienting the printed products, the nip section including a first pair of nip rolls, a second pair of nip rolls and at least one motor driving the first pair of nip rolls and the second pair of nip rolls, the at least one motor driving the first pair of nip rolls at different velocities than the second pair of nip rolls to reorient the printed products.

2. The printing press as recited in claim 1 wherein the nip section decelerates the printed products while reorienting the printed products.

3. The printing press as recited in claim 1 wherein the nip section accelerates the printed products while reorienting the printed products.

4. The printing press as recited in claim 1 wherein the at least one motor includes a first servo motor driving the first pair of nip rolls and a second servo motor driving the second pair of nip rolls.

5. The printing press as recited in claim 4 wherein the first servo motor drives the first pair of nip rolls at a faster rotational velocities than the second servo motor drives the second pair of nip rolls to reorient the printed products.

6. The printing press as recited in claim 1 wherein the at least one motor drives the first pair of nip rolls and the second pair of nip rolls to reorient the printed products at angle between 0° and 180°.

7. The printing press as recited in claim 1 wherein the at least one motor drives the first pair of nip rolls and the second pair of nip rolls to reorient a first of the printed products at a first angle and a second of the printed products at a second angle.

8. The printing press as recited in claim 1 wherein the printed products include first printed products and second printed products, the nip section reorienting the first printed products in a first direction by the at least one motor driving the first pair of nip rolls at faster rotational velocities than the at least one motor drives the second pair of nip rolls, the nip section reorienting the first printed products in a second direction by the at least one motor driving the first pair of nip rolls at slower rotational velocities than the at least one motor drives the second pair of nip rolls.

9. The printing press as recited in claim 1 further comprising at least one jaw cylinder upstream of the nip section for cross-folding the printed products.

10. The printing press as recited in claim 9 further comprising at least one jaw cylinder downstream of the nip section for quarter-folding the printed products.

11. The printing press as recited in claim 1 wherein the first pair of nip rolls includes a first nip roll and a second nip roll and the second pair of nip rolls includes a third nip roll and a fourth nip roll, the at least one motor rotating the first nip rolls about a first axis and the second nip roll about a second axis at first velocities, the at least one motor rotating the third nip roll about the first axis and the fourth nip roll about the second axis at second velocities.

12. The printing press as recited in claim 1 further comprising a second nip section downstream of the first nip section, the first nip section reorienting first printed products of the printed products into a first stream, the second nip section reorienting second printed products of the printed products into a second stream separate from the first stream.

13. The printing press as recited in claim 12 wherein a center of the first nip section is laterally offset in a first direction from a center of the printed products entering the first nip section and a center of the second nip section is laterally offset in a second direction from the center of the printed products entering the first nip section.

14. The printing press as recited in claim 13 wherein the first nip section reorients the first printed products so the center of the first printed products align with the center of the first nip section as the first printed products exit the first nip section, the second nip section reorienting the first printed products so the center of the second printed products align with the center of the second nip section as the second printed products exit the second nip section.

15. The printed press as recited in claim 1 further comprising a delivery fan downstream of the nip section.

16. The printed press as recited in claim 15 further comprising a slow-down device between the nip section and the delivery fan.

17. A method for reorienting printed products in printing press comprising the steps of:
controlling a printed product with a first pair and a second pair of nip rolls;
reorienting the printed product by rotating the first pair of nip rolls at first velocities and rotating the second pair of nip rolls at second velocities different from the first velocities; and
releasing the printed product from the first pair and second pair of nip rolls.

18. The method as recited in claim 17 further comprising the step of:
rotating the first pair of nip rolls and second pair of nip rolls at an equal velocity before the controlling step.

19. The method as recited in claim 17 further comprising the step of:
rotating the first pair of nip rolls and second pair of nip rolls at an equal velocity when the printed product exits the first and second pairs of nip rolls during the releasing step.

20. The method as recited in claim 17 wherein the printed product is transported in a transport direction during the reorienting step, the reorienting step including turning the printed product from an initial orientation where a trailing edge of the printed product is parallel to the transport direction to a new orientation where the trailing edge is angled with respect to the transport direction.

21. The method recited in claim 17 further comprising:
controlling a second printed product with the first pair and the second pair of nip rolls; and
reorienting the second printed product by rotating the first pair of nip rolls at third velocities and rotating the second pair of nip rolls at forth velocities different from the third velocities, the second printed product being reoriented in a different direction than the first printed product.

22. The method as recited in claim 21 wherein the first velocities are greater than the second velocities and the third velocities are less than the fourth velocities.

23. The method as recited in claim 17 further comprising:
passing a second printed product through the first pair and second pair of nip rolls;
controlling the second printed product with third first pair and a fourth pair of nip rolls; and
reorienting the second printed product by rotating the third pair of nip rolls at third velocities and rotating the fourth pair of nip rolls at fourth velocities different from the third velocities.

24. The method as recited in claim 23 further comprising releasing the second printed product from the third pair and fourth pair of nip rolls so the second printed product is aligned laterally adjacent to the printed product.

25. The method as recited in claim 16 wherein the printed product includes an open edge and a closed edge, the printed product being reoriented from an initial position with the open edge leading to a new position with the closed edge leading.
